(19) United States
(12) Patent Application Publication
(10) Pub. No.: US 2026/0331787 A1
(43) Pub. Date: Oct. 22, 2026

(54) Reactive Beamforming Metasurface

(71) Applicant: The Regents of The University of Michigan, Ann Arbor, MI (US)

(72) Inventors: Anthony GRBIC, Ann Arbor, MI (US); Malik ALMUNIF, Ann Arbor, MI (US); Faris ALSOLAMY, Ann Arbor, MI (US)

(73) Assignee: The Regents of The University of Michigan, Ann Arbor, MI (US)

(21) Appl. No.: 19/650,914

(22) Filed: Apr. 17, 2026

Related U.S. Application Data
(60) Provisional application No. 63/790,212, filed on Apr. 17, 2025.

(51) Int. Cl. H01Q 25/00; H01Q 3/30; H01Q 15/00; H04B 7/0426

(52) U.S. Cl. CPC H01Q 25/001; H01Q 3/30; H01Q 15/0086; H04B 7/043

(57) ABSTRACT

A beamforming apparatus is presented. The beamforming apparatus is comprised of an electromagnetic metasurface disposed on a top surface of a substrate and configured to produce simultaneous beams; and a load layer disposed on a bottom surface of the substrate. The metasurface may be divided into a plurality of unit cells, such that two or more excitation sources are electromagnetically coupled or electrically connected to respective unit cells in the plurality of unit cells and the remainder of unit cells in the plurality of unit cells are electromagnetically coupled or electrically connected to respective electrical loads. The metasurface is simulated with a full-wave solver to extract an impedance matrix and the ports are loaded with reactive terminations to control the wavefront.

### CROSS REFERENCE TO RELATED APPLICATIONS

This application claims the benefit and priority of U.S. Provisional Application No. 63/790,212 filed on Apr. 17, 2025. The entire disclosure of the above application is incorporated herein by reference.

### FIELD

The present disclosure relates to network-based technique for designing beamforming metasurfaces.

### BACKGROUND

Metasurfaces offer unprecedented control over electromagnetic wavefronts, owing to their ability to manipulate amplitude, phase, and polarization. Their subwavelength texture enables low-profile alternatives to bulky conventional devices. Advancements in metasurface design have shown great promise across a range of applications, particularly in enhancing wireless communications for 5G and 6G networks. These enhancements rely on beamforming metasurfaces, used to shape and steer the radiated field.

To achieve these capabilities, various techniques have been used to design beamforming metasurfaces. One such technique is the local periodicity approximation, in which each unit cell is designed as if it were embedded in a periodic environment. Although this approach can approximately control the phase of the wavefront, it cannot achieve amplitude control since it neglects intercell interactions between aperiodic unit cells.

An alternative technique employs the Method of Moments for precise modeling of beamforming metasurfaces. This technique has been used to design transmissive and reflective beamforming metasurfaces. Homogenized models of the unit cells are typically used and cell interactions are modeled via the Green's function. Despite its advantages, multiple basis functions are used for each unit cell to accurately represent the metasurface. Thus, acceleration techniques are required for efficient inversion of the large matrix equation describing the metasurface. Subsequently, the homogenized cells must be realized as patterned geometries using extraction techniques.

Another strategy is to rely on an impedance matrix, which accurately models electromagnetic interactions between multiple ports. This technique allows the metasurface to be represented as a grid of unit cells. Each unit cell is represented by a single port instead of multiple basis functions, significantly reducing the size of the linear system compared to the integral equation method. The impedance matrix of the metasurface can be computed once using a commercial full-wave electromagnetic solver and then used to design the reactive loads that terminate the ports to realize targeted field patterns. For example, the impedance matrix for a transponder was used to improve the efficiency of wireless power transfer through the optimization of reactive impedances. This technique achieved increased efficiency in wireless power transfer systems, but also holds promise for full control of an electromagnetic wavefront.

In this disclosure, an impedance matrix is extracted via a full-wave solver to design beamforming metasurfaces. The metasurface can function as a reflector or as a directly fed antenna by simply changing the loads. The designed metasurfaces provide full control over the amplitude and phase of the wavefront in both configurations. Additionally, the metasurface supports multi-input multi-output beamforming, showcasing the versatility and advanced capabilities possible. The proposed technique is applied to a metasurface consisting of an aperture-coupled unit cells with reactive loads attached. The unit cell isolates the reactive load from the radiated field.

This section provides background information related to the present disclosure which is not necessarily prior art.

### SUMMARY

This section provides a general summary of the disclosure, and is not a comprehensive disclosure of its full scope or all of its features.

A beamforming apparatus is presented. The beamforming apparatus is comprised of an electromagnetic metasurface disposed on a top surface of a substrate and configured to produce simultaneous beams; and a load layer disposed on a bottom surface of the substrate. The metasurface may be divided into a plurality of unit cells, such that two or more excitation sources are electromagnetically coupled or electrically connected to respective unit cells in the plurality of unit cells and the remainder of unit cells in the plurality of unit cells are electromagnetically coupled or electrically connected to respective electrical loads. The metasurface is simulated with a full-wave solver to extract an impedance matrix and the ports are loaded with reactive terminations to control the wavefront.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a diagram of a proposed beamforming apparatus.

FIG. 2 is a schematic of an impedance network representation of the metasurface.

FIG. 3 is a flowchart showing an example technique for synthesizing radiation patterns for a multiport metasurface.

FIGS. 4A and 4B are top and side views, respectively, of a unit cell.

FIG. 5A shows the optimized reactive load distribution for design I that realizes a uniform aperture that radiates towards (θ, φ)=(−30°, 0°); only half the impedances are shown due to symmetry.

FIG. 5B shows the radiation pattern extracted using Ansys HFSS with the loads attached to the unit cells.

FIG. 5C is a graph showing the normalized radiation pattern in dB along the E-plane (φ=0°).

FIG. 6 shows the spectral current at the ports for design I; the propagating spectrum is shown inside the circle.

FIG. 7A shows the optimized reactive load distribution for design II that realizes a flat-top radiation pattern; only half the impedances are shown due to symmetry.

FIG. 7B is a graph showing the normalized radiation pattern extracted from Ansys HFSS in dB along three different planes. The plot has three regions: the blue region shows the flat-top requirement, the grey region is a transition region, and the third region restricts sidelobe levels.

FIG. 8A shows the optimized reactive load distribution for design III that realizes a multiple-input multiple-output; only half the impedances are shown due to symmetry.

FIGS. 8B and 8C show the radiation pattern extracted using Ansys HFSS with the loads attached to the unit cells.

FIG. 8D is a graph showing the normalized radiation pattern in dB along the H-plane (φ=90°).

FIG. 9A shows the reflective metasurface for design IV is excited by a plane wave incident from (θi, φi)=(30°, 0°) and the desired reflected field consist of two beams on the orthogonal azimuthal plane (θ, φ)=(±30°, 90°).

FIG. 9B shows the optimized reactive load distribution; only half the impedances are shown due to symmetry.

FIG. 9C shows the radiation pattern extracted using Ansys HFSS with the loads attached to the unit cells.

FIG. 9D is a graph showing the normalized radiation pattern in dB along the H-plane (φ=90°).

FIG. 10A shows the reflective metasurface for design V; a plane wave incident from (θi, φi)=(30°, 0°) is reflected towards (θ, φ)=(−30 °, 90°) and a plane wave incident from (θi, φi)=(30°, 90°) is reflected towards (θ, φ)=(−30°, 0°).

FIG. 10B shows the optimized reactive load distribution.

FIGS. 10C-10F show the normalized radiation pattern extracted using Ansys HFSS with the loads attached to the unit cells when excited by: (c-d) First plane wave and (e-f) Second plane wave.

FIG. 11 is a network representation of a non-local metasurface, where the center cell is excited by a voltage source and the rest are terminated with a coupling network that includes self-admittances and nearest-neighbor coupling admittances.

FIG. 12 is a flowchart depicting another example technique for synthesizing radiation patterns for a metasurface;

FIG. 13 is a diagram of a metasurface having aperture-coupled unit cells.

FIGS. 14A and 14B are graphs showing amplitude and phase distribution of voltages, respectively, across the unit cells of a metasurface design with a Dolph-Chebyshev radiation pattern.

FIGS. 14C and 14D are graphs showing calculated self-admittance and nearest-neighbor coupling admittance for the metasurface design with a Dolph-Chebyshev radiation pattern.

FIG. 15 is a graph showing a comparison between a synthesized radiation pattern and the target Dolph-Chebyshev radiation pattern.

FIGS. 16A and 16B are graphs showing amplitude and phase distribution of voltages, respectively, across the unit cells of a metasurface design with a flat-top radiation pattern.

FIGS. 16C and 16D are graphs showing calculated self-admittance and nearest-neighbor coupling admittance for the metasurface design with the flat-top radiation pattern.

FIG. 17 is a graph showing a comparison between a synthesized radiation pattern and the target flat-top radiation pattern.

FIGS. 18A and 18B are graphs showing amplitude and phase distribution of voltages, respectively, across the unit cells of a metasurface design with a multi-beam radiation pattern.

FIGS. 18C and 18D are graphs showing calculated self-admittance and nearest-neighbor coupling admittance for the metasurface design with the multi-beam radiation pattern.

FIG. 19 is a graph showing a comparison between a synthesized radiation pattern and the target multi-beam radiation pattern.

FIG. 20 is a diagram of a N-port TT-equivalent circuit representation for a coupling network.

FIG. 21 is a diagram of a physical realization of the coupling network using microstrip interconnections and lumped or distributed reactive loads.

FIG. 22A is a diagram depicting a bottom layer layout of a metasurface showing an implemented coupling network.

FIG. 22B is a graph showing the radiation pattern of the realized metasurface.

FIG. 22C is a graph showing the reflection coefficient of the realized metasurface.

Corresponding reference numerals indicate corresponding parts throughout the several views of the drawings.

### DETAILED DESCRIPTION

Example embodiments will now be described more fully with reference to the accompanying drawings.

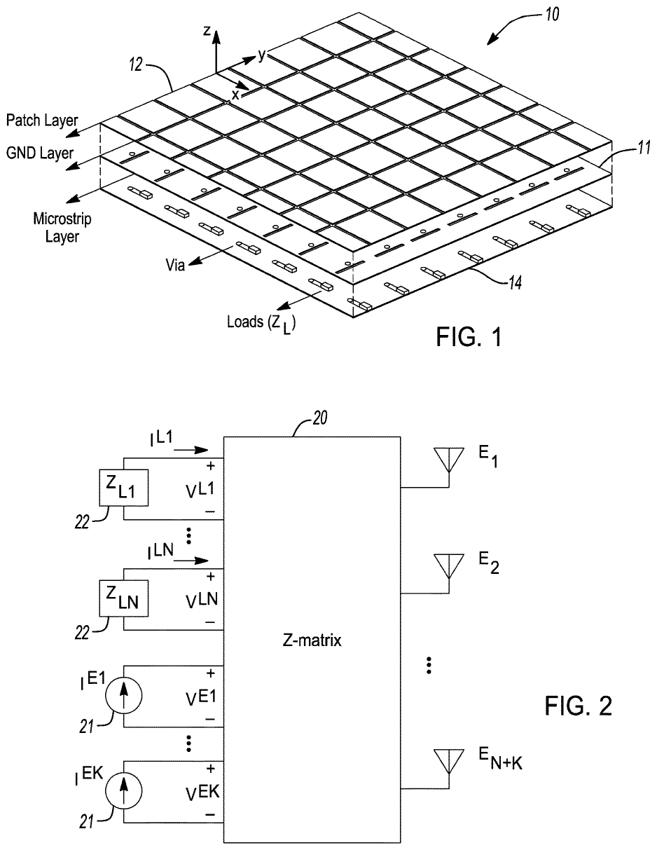

FIG. 1 depicts a proposed beamforming apparatus 10. The beamforming apparatus is comprised of: a substrate 11; an electromagnetic metasurface 12, and a load layer 14. The electromagnetic metasurface 12 is disposed on a top surface of the substrate 11 and is configured to produce simultaneous beams. The metasurface 12 is divided into a plurality of unit cells. Although shown as squares, other geometries are envisioned for the unit cells.

The load layer 14 is disposed on a bottom surface of the substrate 11 and supports a plurality of electrical loads. The metasurface is simulated with a full-wave solver to extract an impedance matrix and the ports are loaded with reactive terminations to control the wavefront. A direct solution of the loads needed to achieve a desired radiation pattern is derived as further described below.

In one embodiment, the two or more excitation sources 21 are electromagnetically coupled or electrically connected to respective unit cells in the plurality of unit cells and remainder of unit cells in the plurality of unit cells are electromagnetically coupled or electrically connected to in respective electrical loads 22 as seen in FIG. 2. Other embodiments may be entirely reflective with the excitation sources being external to the beamforming apparatus. In this case, the unit cells are only terminated in respective electrical loads. It is understood that the electrical loads may be electrically connected through the substrate to the metasurface or electromagnetically coupled to the metasurface through apertures formed in the substrate. It is also envisioned that the electrical loads may be tunable.

With continued reference to FIG. 2, the metasurface is represented by its impedance matrix 20. It consists of M=N+K unit cells, where N of these cells are terminated by loads and K of them are directly excited. The relationship between the excitations and terminations in the network can be expressed using an impedance matrix as,

$$[ \begin{matrix}{\overline{V}}^{L} \\ {\overline{V}}^{E}\end{matrix} ] = [ \begin{matrix}{\overline{\overline{Z}}}^{LL} & {\overline{\overline{Z}}}^{LE} \\ {\overline{\overline{Z}}}^{EL} & {\overline{\overline{Z}}}^{EE}\end{matrix} ] [ \begin{matrix}{\overline{I}}^{L} \\ {\overline{I}}^{E}\end{matrix} ] \qquad ( 1 )$$

where the superscripts L and E denote the loads (terminations) and excitations, respectively. In this formulation, Z̅^{LL} is an N×N matrix representing coupling between the terminated ports, Z̅^{EE} is a K×K matrix representing coupling between the excitations, and Z̅^{LE} and Z̅^{EL} denote the coupling between the terminations and excitations. Thus, assume there are N loads and K excitations. The excitations produce voltages across the loads, which can be directly related to the load current and the load impedance,

V̅^{L}=Ī^{L}Z̅^{L} (2)
where Z̅^{L} is a diagonal matrix containing the load impedances at each terminated port. Then, one can rewrite (1) by incorporating (2),

$$[ \begin{matrix}\overline{0} \\ {\overline{V}}^{E}\end{matrix} ] = [ \begin{matrix}{\overline{\overline{Z}}}^{LL} + {\overline{\overline{Z}}}_{l} & {\overline{\overline{Z}}}^{LE} \\ \overline{\overline{Z}} EL & {\overline{\overline{Z}}}^{EE}\end{matrix} ] [ \begin{matrix}{\overline{I}}^{L} \\ {\overline{I}}^{E}\end{matrix} ] \qquad ( 3 )$$

This formulation yields two equations. Using the first row of (3) and some simple algebraic manipulation, one can analytically derive the required impedances as,

Z̅_{L}=[−Z̅^{LE}Ī^{E}−Z̅^{LL}Ī^{L}]ØĪ^{L} (4)
where Ø denotes the Hadamard element-wise division, and I^{E} and I^{L} are the currents at the ports required to achieve a desired radiation pattern. The parameter −Z̅^{LE} Ī^{E} is a voltage excitation V̅_{exc} on the unit cells. Thus, a general form for any type of excitation can be written as,

Z̅_{L}=V̅_{exc}−Z̅^{LL}Ī^{L}]ØĪ^{L} (5)

This equation relates the load impedances to the current at port. An accurate synthesis technique of these currents to produce desired radiation patterns is presented next.

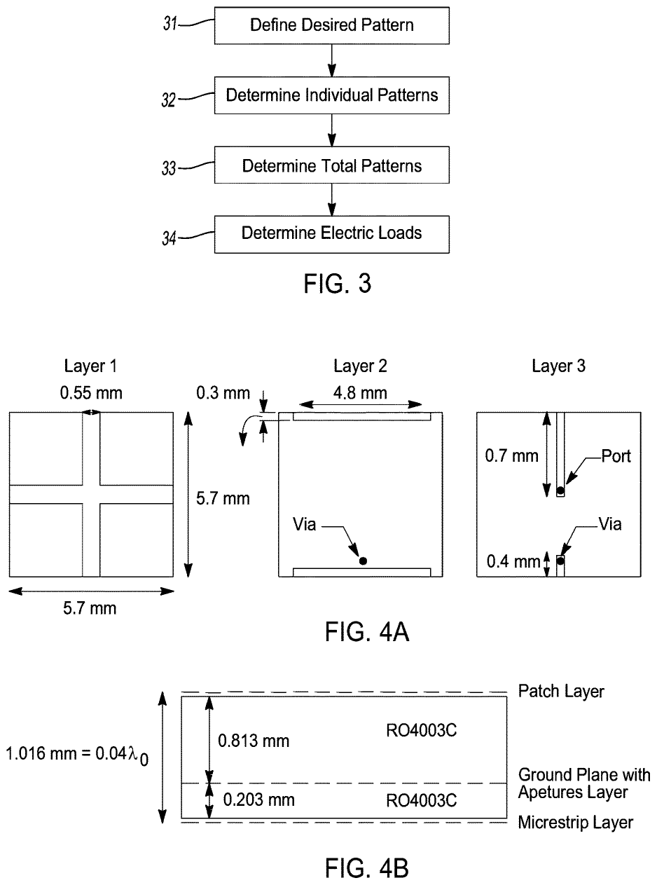

An example technique for synthesizing radiation patterns for a multiport metasurface is described in relation to FIG. 3. The desired radiation pattern is decomposed into the element pattern of the unit cells to derive the required excitation current for each unit cell.

As a starting point, the desired radiation pattern is defined at 31. The desired radiation pattern can be expressed as a weighted sum of the element patterns corresponding to the unit cells,

$${E}_{des} ( θ , ϕ ) = {\sum }_{m = 1}^{M} {I}_{m} {E}_{m} ( θ , ϕ ) \qquad ( 6 )$$

where M=N+K represents the total number of unit cells. Iₘ denotes the excitation current at each unit cell, and

$${E}_{m} ( θ , ϕ ) = {E}_{m}^{θ} ( θ , ϕ ) \hat{θ} + {E}_{m}^{ϕ} ( θ , ϕ ) \hat{ϕ}$$

represents the element pattern in spherical coordinates for each unit cell as a function of the elevation angle θ and the azimuthal angle φ. The objective is to determine the required currents, Iₘ, that produce the desired radiation pattern.

Next, individual radiation patterns are determined at 32 for each of the unit cells comprising the metasurface. Individual radiation patterns are determined, for example using an electromagnetic field solver. A total radiation pattern for the metasurface is then determined at 33 based in part of the individual radiation patterns. More specifically, the total radiation pattern is determined by setting excitation currents of the two or more excitation sources; calculating the load currents for unit cells terminated with electrical loads using the impedance matrix; and superimposing individual radiation patterns for each unit cell, where the individual radiation patterns are weighted by their respective load current.

To solve for the currents, begin by taking the inner product of (6) with the conjugate of element pattern E₁ (θ,φ),

$${\int }_{0}^{2 π} {\int }_{0}^{π} {E}_{1}^{*} \cdot {E}_{des} d θ d ϕ = {I}_{1} {\int }_{0}^{2 π} {\int }_{0}^{π} {E}_{1}^{*} \cdot {E}_{1} d θ d ϕ + {I}_{2} {\int }_{0}^{2 π} {\int }_{0}^{π} {E}_{1}^{*} \cdot {E}_{2} d θ d ϕ + ⋯ + {I}_{M} {\int }_{0}^{2 π} {\int }_{0}^{π} {E}_{1}^{*} \cdot {E}_{M} d θ d ϕ \qquad ( 7 )$$

This process is repeated for E₂(θ, φ) to Eₘ(θ, φ)). This yields M linear equations corresponding to the M unknown currents. The resulting equations can be written in matrix form, as in (8).

$$[ \begin{matrix}{\int }_{0}^{2 π} {\int }_{0}^{π} {E}_{1}^{*} \cdot {E}_{des} \\ {\int }_{0}^{2 π} {\int }_{0}^{π} {E}_{2}^{*} \cdot {E}_{des} \\ ⋮ \\ {\int }_{0}^{2 π} {\int }_{0}^{π} {E}_{M}^{*} \cdot {E}_{des}\end{matrix} ] = [ \begin{matrix}{\int }_{0}^{2 π} {\int }_{0}^{π} {E}_{1}^{*} \cdot {E}_{1} & {\int }_{0}^{2 π} {\int }_{0}^{π} {E}_{1}^{*} \cdot {E}_{2} & ⋯ & {\int }_{0}^{2 π} {\int }_{0}^{π} {E}_{1}^{*} \cdot {E}_{M} \\ {\int }_{0}^{2 π} {\int }_{0}^{π} {E}_{2}^{*} \cdot {E}_{1} & {\int }_{0}^{2 π} {\int }_{0}^{π} {E}_{2}^{*} \cdot {E}_{2} & ⋯ & {\int }_{0}^{2 π} {\int }_{0}^{π} {E}_{2}^{*} \cdot {E}_{M} \\ ⋮ & ⋮ & ⋱ & ⋮ \\ {\int }_{0}^{2 π} {\int }_{0}^{π} {E}_{M}^{*} \cdot {E}_{1} & {\int }_{0}^{2 π} {\int }_{0}^{π} {E}_{M}^{*} \cdot {E}_{2} & ⋯ & {\int }_{0}^{2 π} {\int }_{0}^{π} {E}_{M}^{*} \cdot {E}_{M}\end{matrix} ] [ \begin{matrix}{I}_{1} \\ {I}_{2} \\ ⋮ \\ {I}_{M}\end{matrix} ] \qquad ( 8 )$$

Equation (8) can be solved to determine the required current excitation for each unit cell. Once these currents are known, one can find the load impedances by employing (5). In general, the resulting load impedances are complex, i.e., they include both real and imaginary components. The real component indicates either loss or gain within each unit cell. Consequently, optimization is required to avoid the use of active or lossy elements. Through optimization, purely reactive loads can be found that are capable of shaping and steering the radiation. This procedure is detailed in the next section.

In the example embodiment, optimization is required to produce purely reactive loads that meet the desired far-field specifications. The imaginary parts of the analytically derived complex impedances, calculated using (5), are used as a seed for the optimization. Ignoring the real part alters the current at each port, and the new set of currents can be calculated using (5),

$${\overline{I}}^{L} = {[ j {\overline{\overline{X}}}_{L} + {\overline{\overline{Z}}}^{LL} ]}^{- 1} {\overline{V}}_{exc} \qquad ( 9 )$$

where X̅_{L} is a diagonal matrix containing the imaginary parts of the complex impedances. Once the new set of currents is obtained, the radiation pattern can be computed using the element pattern of each unit cell using,

$${E}_{tot} ( θ , ϕ ) = {\sum }_{n = 1}^{N} {I}_{n}^{L} {E}_{n} ( θ , ϕ ) + {\sum }_{k = 1}^{K} {I}_{k}^{E} {E}_{k} ( θ , ϕ ) \qquad ( 10 )$$

where Eₜₒₜ(θ, φ) denotes the total field radiated by the metasurface, and Eₙ(θ, φ) and Eₖ(θ, φ) denote the element patterns for the terminated and excited cells, respectively.

To find the optimal reactive loads, the MATLAB built-in function fmincon is used. The optimization objective is to find passive and lossless loads that achieve the desired radiation pattern and provide specific scattering coefficients. That is, the total radiation pattern is aligned to the desired radiation pattern at 34 to determine values for the loads. In general, the cost function is defined as

g=minimize{E_{des}−Eₜₒₜ}+minimize{Γ}
where E_{des} is the desired radiation pattern, Eₜₒₜ is the total radiation pattern and Γ is a reflection coefficient matrix. More specifically, the optimization cost function is defined as follows,

$$\\ \begin{matrix}g = α {\sum }_{θ = 0}^{π} {\sum }_{ϕ = 0}^{2 π} {\vert {E}_{des} ( θ , ϕ ) - {E}_{tot} ( θ , ϕ ) \vert}^{2} + β {\sum }_{i = 1}^{K} \vert {S}_{ii} \vert + γ {\sum }_{i = 1}^{K - 1} {\sum }_{j = i + 1}^{K} \vert {S}_{ij} \vert & ( 11 )\end{matrix}$$

where E_{des} (θ, φ) denotes the desired radiation pattern, Eₜₒₜ (θ, φ) is the total field radiated by the metasurface with the reactive loads attached, Sᵢᵢ represents the reflection coefficient at the excited ports when the loads are attached, and Sᵢⱼ is representative of the coupling between ports with the loads attached. The constants α, β, and γ serve as weighting factors.

In this embodiment, the first term in (11) aligns the actual radiated field with the desired radiated field. This term is applicable to both reflective and directly-fed metasurfaces. The second term is used to minimize reflection at the ports, while the third term is used to enhance port isolation. The last two terms are used specifically for directly-fed metasurfaces and they are derived below.

The optimization is seeded with the reactive parts of the complex loads obtained using (5). The optimization iteratively updates the reactive loads until the cost function is minimized.

A directly-fed metasurface design is further described. In other words, consider a scenario where certain unit cells are excited, while the other unit cells are terminated with reactive loads to control the radiated field and scattering parameters. The radiated field can be computed directly using (9) and (10). The voltage V̅_{exc} appearing in (9) is equal to −Z̅^{LE}Ī^{E}. Then, to determine the scattering parameters of the excitation ports, the full impedance matrix in (1) of dimension (N+K)×(N+K) is reduced to an impedance matrix of dimension K×K. This reduction process begins by using the relationship between the voltages and currents at the excitation ports as expressed in the second row of (1),

V̅^{E}=Z̅^{EL}Ī^{L}+Z̅^{EE}Ī^{E} (12)

Substituting (9) into the equation above for Ī^{L}, one obtains,

$$\\ \begin{matrix}{\overline{V}}^{E} = {\underbrace{[ {{\overline{\overline{Z}}}^{EL} [ - j {\overline{\overline{X}}}_{L} - {\overline{\overline{Z}}}^{LL} ]}^{- 1} {\overline{\overline{Z}}}^{LE} + {\overline{\overline{Z}}}^{EE} ]}}_{{Z}^{=}} {\overline{I}}^{E} & ( 13 )\end{matrix}$$

Thus, V̅^{E}=Z̅Ī^{E}, where Z̅ is the reduced impedance matrix relating excited ports. Then convert the impedance matrix Z̅ to a scattering matrix S̅,

S̅=(Z̅+Z̅₀)⁻¹(Z̅−Z̅₀) (14)
where Z̅₀ is a diagonal matrix containing the source impedances of each excitation port.

A reflective metasurface design is also described. In this design, the metasurface can serve as a reflector by terminating all the ports with reactive loads. In this case, the metasurface is illuminated by an external incident field. The total reflected field Eₜₒₜ (θ, φ) by the metasurface is calculated using superposition,

$$\\ \begin{matrix}{E}_{tot} ( θ , ϕ ) = {E}_{s} ( θ , ϕ ) {\vert}_{{Z}_{L} = ∞} - {\sum }_{n = 1}^{N} {I}_{n}^{L} {E}_{n} ( θ , ϕ ) & ( 15 )\end{matrix}$$

where Eₛ(θ, φ)|Z_{L}=∞ represents the scattered field when all the loads are open-circuited, which is pre-calculated for a given incident field. Equation (15) can be used to determine the field produced by the loads to achieve the desired reflected field,

$$\\ \begin{matrix}{\sum }_{n = 1}^{N} {I}_{n}^{L} {E}_{n} ( θ , ϕ ) = {E}_{s} ( θ , ϕ ) {\vert}_{{Z}_{L} = ∞} - {E}_{des} ( θ , ϕ ) & ( 16 )\end{matrix}$$

The port current

$${I}_{n}^{L}$$

at each unit cell can be analytically calculated using equation (8). This current is related to the load impedance using (9), where in this case V_{exc} is the open-circuit voltage v̅_{oc} induced by the incident field. The open-circuit voltage at each unit cell can be computed using the vector effective length, [symbol] ₑ, as follows,

$$\\ \begin{matrix}{v}_{oc}^{n} = {E}_{i} \cdot {ℒ}_{e} & ( 17 )\end{matrix}$$

where Eᵢ is the incident field. The vector effective length is related to the unit cell's element pattern using,

$$\\ \begin{matrix}{ℒ}_{e} = \frac{j 4 π {re}^{{jk}_{0} r}}{{k}_{0} {η}_{0} {I}_{0}} {E}_{n} ( θ , ϕ ) & ( 18 )\end{matrix}$$

where k₀ is the wavenumber, η₀ is the wave impedance, I₀ is the current used to extract the element pattern, and r is the radius where the radiated field is evaluated. Therefore, the open-circuit voltage is equal to,

$$\\ \begin{matrix}{v}_{oc}^{n} = \frac{j 4 π {re}^{{jk}_{0} r}}{{k}_{0} {η}_{0} {I}_{0}} {E}_{i} \cdot {E}_{n} ( θ , ϕ ) & ( 19 )\end{matrix}$$

Assuming the incident field is a plane wave, Eᵢ=\hat{p}E₀e^{ik·r}, where \ddot{p} is the polarization of the incident plane wave. The dot product in (19) simplifies to,

$$\\ \begin{matrix}{E}_{i} \cdot {E}_{n} ( θ , ϕ ) = {E}_{n}^{p} ( {θ}_{i} , {ϕ}_{i} ) & ( 20 )\end{matrix}$$

Once the open-circuit voltage at each unit cell is known, the load impedance can be computed. The analytically calculated load impedances are generally complex. Optimization is employed to obtain purely imaginary impedances, which achieve the required field transformation. The method here allows the control of both the shape and direction of the reflected field. This enables the control of reflections into multiple directions.

Key design steps for directly-fed and reflective metasurfaces are as follows:
1) Use full-wave electromagnetic solver to obtain the impedance matrix of the metasurface and the simulated element pattern for each unit cell.
2) Stipulate a desired radiation pattern.
3) Compute the required current excitations to produce the specified desired far-field pattern using (8).
4) Calculate the complex load impedances necessary to achieve the desired radiation pattern using (5).
5) Remove the real component of the complex impedance, and use the reactances as a seed for optimization.
6) Employ MATLAB's built-in optimization function fmincon to minimize the cost function presented in (11) by adjusting the load reactances.

This method can be applied to any metasurface unit cell.

As proof of concept, an aperture-coupled unit cell is selected to validate the design approach. The aperture-coupled cell shields the reactive load from external electromagnetic radiation, thereby limiting spurious radiation from the loads. Additionally, isolating the loads from the radiating element allows the same metasurface to function as either a directly-fed antenna or a reflector by simply changing the connected loads. Furthermore, this unit cell allows for simple realization of the reactive loads. The unit cell of the metasurface is shown in FIGS. 4A and 4B. This cell consists of two stacked RO4003C substrates with relative permittivity ϵᵣ=3.55. The cell is composed of three layers: the first layer comprises a metallic patch that is printed on top of a dielectric substrate. The second layer is a ground plane perforated with a slot to enable aperture coupling between the first and third layers. A via, that is located near the slot, connects the perforated ground layer to the final microstrip layer. It acts as a short to increase the magnetic field, and as a result, coupling through the slot. The final microstrip layer has a 500 microstrip line, positioned orthogonal to the slot. A lumped port is connected to the microstrip line on one side and a shorting via on the other. Lumped reactive loads will be placed across the ports of each unit cell to manipulate the radiation pattern.

Consider the operation of the unit cell in receive mode, where a plane wave is incident along the x-axis on the unit cell. This incoming plane wave induces an electric field across the gaps between the patches in the first layer. This field is coupled through the slots in the perforated ground plane layer to the microstrip line in the third layer. The signal in the microstrip line then excites a reactive load attached to the lumped port.

The dimensions of each layer are depicted in FIGS. 4A and 4B. The unit cell is square with each side equal to Δ₀/5, while its overall thickness is 0.04/λ₀. The unit cell is designed for operation at 10 GHZ, and has been optimized to achieve an impedance transformation from the wave impedance of free space 377Ω to a 500 line.

Multiple examples are presented to validate the proposed design approach. In all the examples, the metasurface is assumed to be an 11×11 array of unit cells, approximately spanning a physical area of 2λ₀×2λ₀. The impedance matrix and the element pattern for each unit cell are pre-calculated once and employed throughout the design process. The element pattern for all unit cells is determined from a single simulation of the entire metasurface. In postprocessing, the element pattern of a specific unit cell is extracted by exciting only that unit cell with 1A current while setting the current of all other unit cells to zero (i.e. open-circuiting them).

For this disclosure, assume the desired radiation pattern is due to an array of magnetic dipoles. The array factor can be expressed as,

$$\\ \begin{matrix}AF ( θ , ϕ ) = {\sum }_{a = - ( A - 1 ) / 2}^{( A - 1 ) / 2} {\sum }_{b = - ( B - 1 ) / 2}^{( B - 1 ) / 2} {I}_{ab} {e}^{j ( {k}_{0} ad sin θ cos ϕ )} {e}^{j ( {k}_{0} bd sin θ sin ϕ )} & ( 21 )\end{matrix}$$

where I_{ab} represents the magnitude and phase of each magnetic dipole, d is the center-to-center distance between adjacent cells, and A and B represent the total number of elements along the x-axis and γ-axis, respectively. Furthermore, the element pattern is assumed to be a y-directed magnetic dipole. The normalized element pattern of the magnetic dipole is given by,

E(θ,φ)=−cos φ\hat{θ}+cos θ sinφ\hat{φ} (22)

The desired far-field pattern is then determined by pattern multiplication as,

E_{des}(θ,φ)=AF(θ,φ)E(θ,φ) (23)

In this example, a single element is excited while the remaining elements are terminated with reactive loads. The excited element is positioned at the center of the metasurface, specifically at the 6th row and 6th column. A 50Ω source is attached to the excited element. The objective is to achieve an impedance match to the source and to produce a predetermined radiation pattern. The desired radiation pattern is set to that of a uniform array of y-directed magnetic dipoles directed towards θ₀=−30°, φ₀=0°. Thus, the magnetic current excitation in the array factor (21) is assumed to be in the following form,

I_{ab}=e^{jk}^{₀}^{adsin θ}^{₀}^{cos φ}^{₀}e^{jk}^{₀}^{bdsin θ}^{₀}^{sin φ}^{₀} (24)

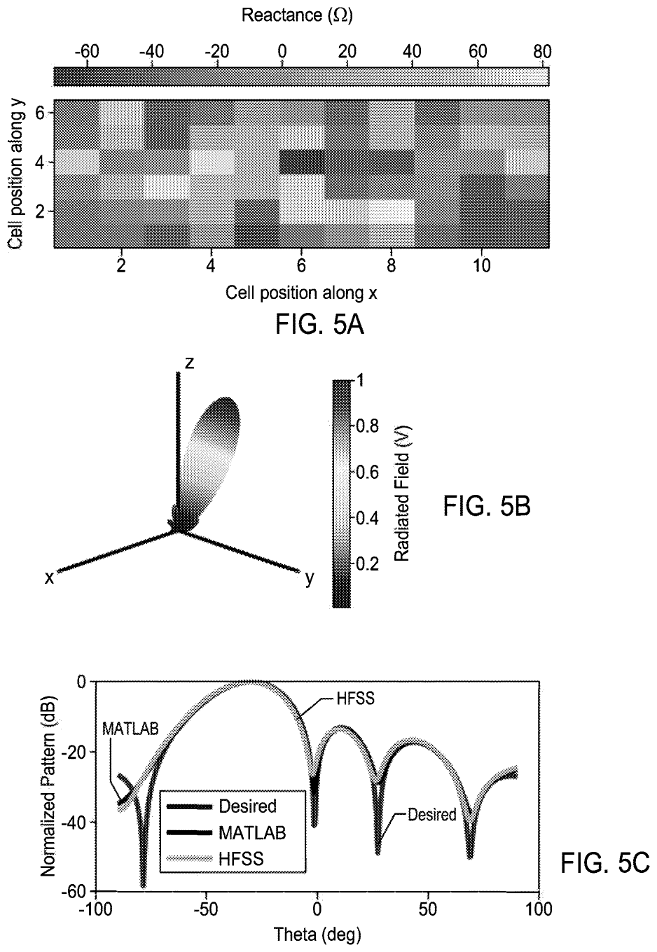

The procedure outlined above is utilized to calculate the initial load currents required to achieve the desired radiation pattern. Then, the reactances are optimized to yield a radiation pattern that closely agrees with the desired pattern. The optimized reactances are depicted in FIG. 5A. Since the structure is symmetric along the y-axis, this symmetry is imposed onto the reactances as well. The optimized reactances are employed in the full-wave electromagnetic solver Ansys HFSS and the resulting radiation pattern is presented in FIG. 5B. The metasurface successfully directs the beam towards the desired direction.

For comparison purposes, the far-field is plotted along the E-plane (φ=) 0°. The results are shown in FIG. 5C, where the desired far-field is shown in blue, the far-field computed in MATLAB using network theory is depicted in black, and the far-field computed using Ansys HFSS (with the loads attached) is represented in green. Close agreement is observed between the desired far-field and the far-field computed from full-wave simulation. The attached loads not only shape the radiated far-field, but also provide an impedance match to the input. Using (14), the reflection coefficient is calculated to be −14.02 dB. In comparison, a reflection coefficient of −14.37 dB is obtained using Ansys HFSS at the operating frequency, demonstrating close agreement between the proposed technique and the full-wave solver.

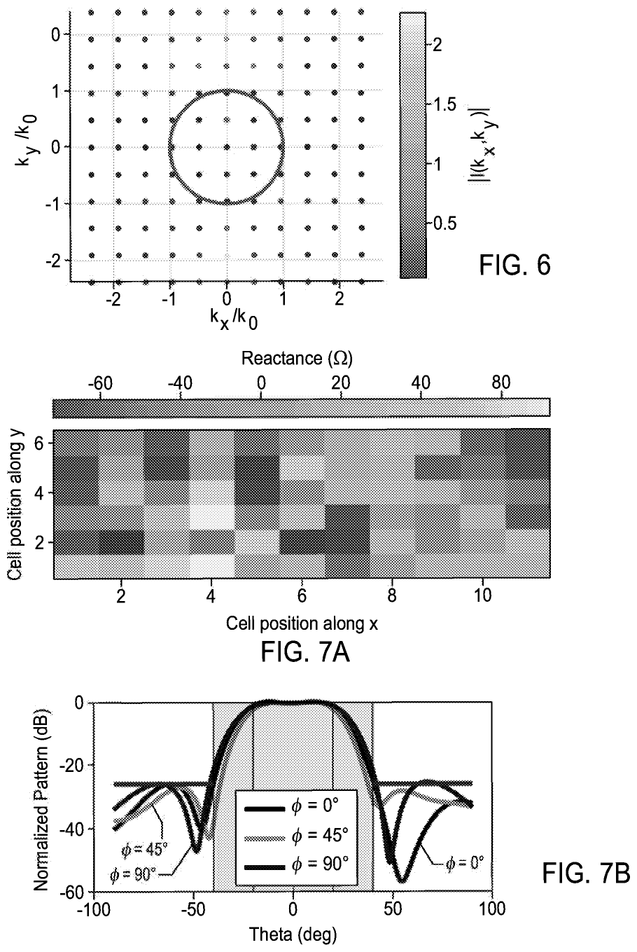

To understand how the reactive loads achieve the desired radiation pattern, one can take a discrete Fourier transform of the calculated currents at the ports. The spectral current distribution for this example is illustrated in FIG. 6. It becomes evidence that the reactive loads adjust the evanescent spectrum to manipulate the radiated field and compensate for the mutual coupling between the cells. The evanescent waves shuttle the power across the aperture to form the desired radiation pattern.

In the second example, the objective is to generate a flattop radiation pattern spanning angles θ=−20° to θ=20° over all azimuthal angles. To achieve such a pattern, the cost function is slightly modified to define a mask with three regions. The first region extends from θ=−20° to θ=20° over which the radiation pattern has a uniform amplitude. The second region is a transition region between the mainlobe and the sidelobe. It extends from θ=±20° to θ=±40°. The final region is a sidelobe region, where the sidelobe level is restricted to be below −13 dB.

Similar to design I, the center element of the metasurface is excited while terminating all other elements with reactive loads. The optimized reactances are shown in FIG. 7A. The resulting radiation pattern extracted from Ansys HFSS is presented in FIG. 7B for three distinct planes. The results clearly illustrate that the reactances accomplish the desired radiation pattern. The metasurface with the loads attached successfully produces a flat-top radiation pattern within the region from θ=−20° to θ=20°. Moreover, the reflection coefficient computed using (14) is −14.65 dB, while the full-wave solver yields a reflection coefficient of −15 dB at the operating frequency.

This example demonstrates the capability of the proposed technique to efficiently control both the amplitude and phase of the aperture.

The proposed technique could also be used to design a multiple-input multiple-output metasurface that is directly-fed. In this example, the objective is to produce two distinct beams with high isolation. The first excited element (feed 1) is in the 6th row and 4th column. The second excited element (feed 2) is in the 6th row and 8th column. They are separated by three cells, a distance approximately equal to 0.6λ₀. The rest of the elements are terminated with reactive loads. The reactive loads are optimized to provide the desired radiation patterns and minimize coupling between feed 1 and feed 2. In order to reduce the coupling, two orthogonal beams are selected as the desired radiation patterns. For radiation along the H-plane (φ=90°), the elevation angles θ that result in orthogonal patterns can be calculated analytically using,

$$\\ \begin{matrix}{θ}_{n} = {sin}^{- 1} \frac{2 π n}{{wk}_{0}} & ( 25 )\end{matrix}$$

where the width of the aperature w=2λ₀. Thus, the elevation angles corresponding to n=±1 are −28.5° (beam 1) and 28.5° (beam 2).

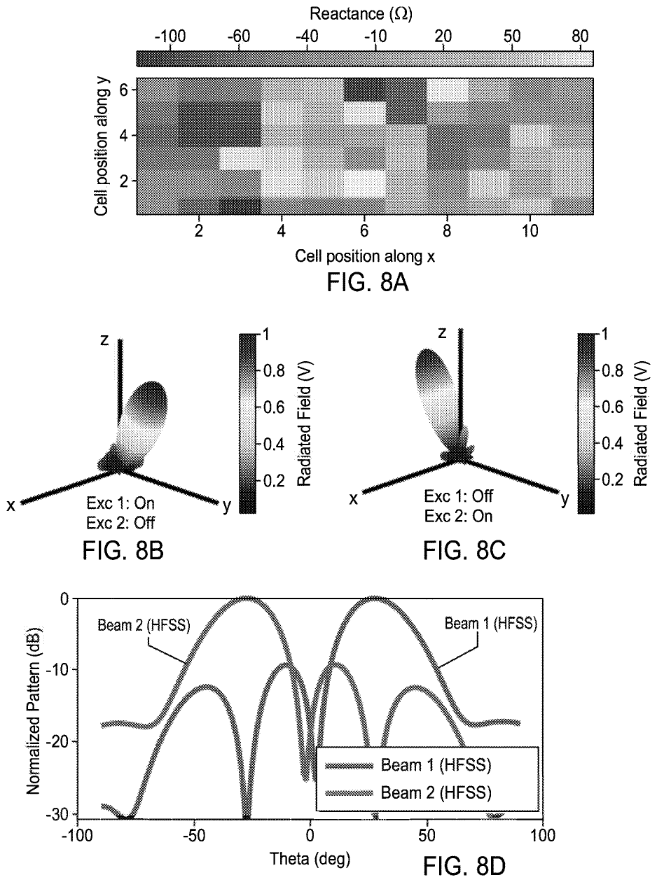

The optimized reactances are shown in FIG. 8A. The reactances are symmetric along the y-axis due to the symmetry of the design. The radiation pattern along the H-plane (φ=) 90° is shown in FIG. 8D. The elevation angle for each feed matches the angles stipulated in the optimization: ±28.5° furthermore, both feeds are matched at the design frequency with a reflection coefficient of −11.3 dB, calculated using (14), while the full-wave solver yields S11=S22=−11 dB. Additionally, the isolation between the feeds is calculated to be −34 dB using (14), compared to −30 dB obtained from the full-wave solver.

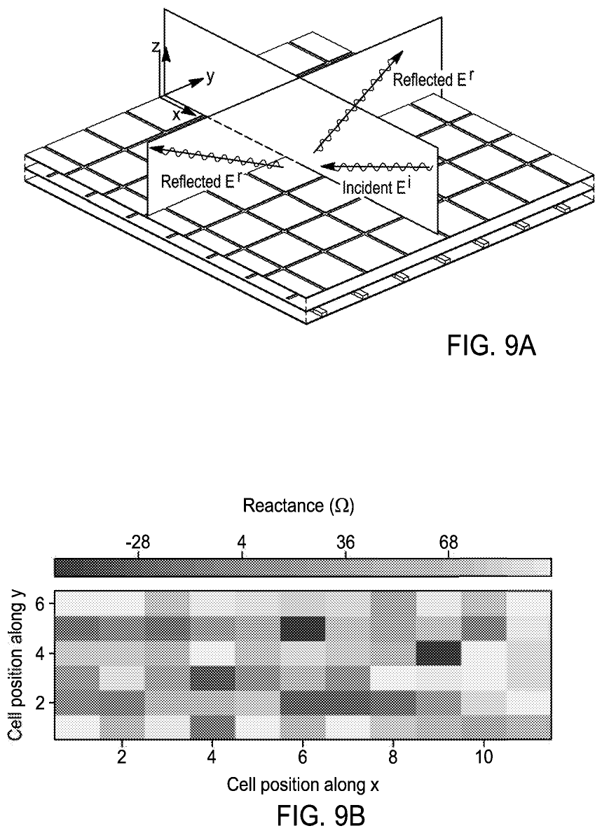

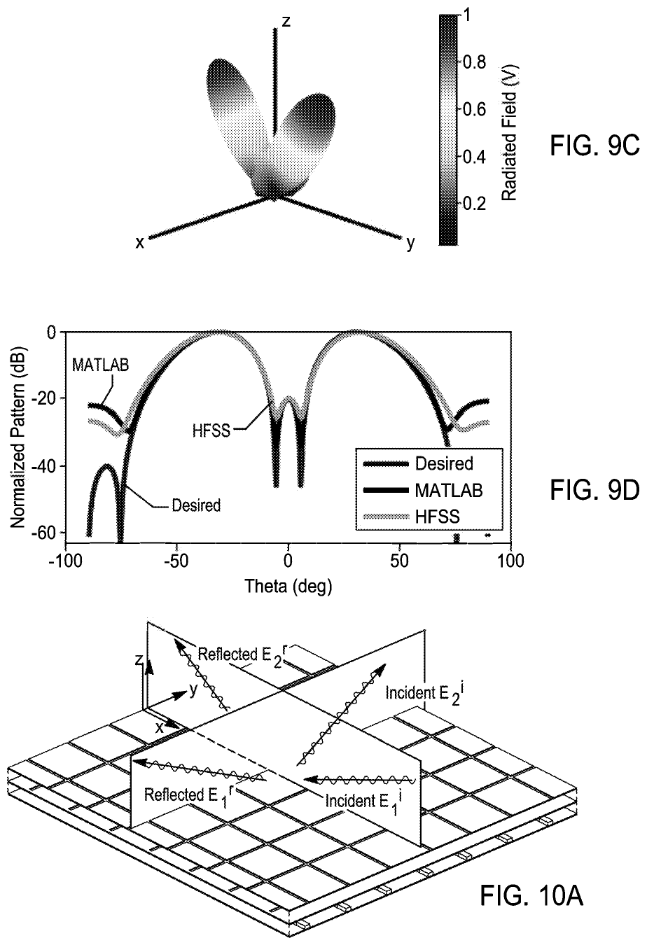

In this example, the goal is to design a beam splitter. The metasurface is excited with a plane wave incident from (θᵢ, φᵢ)=(30°,0°) The objective is to reflect and split the beam into two distinct directions, specifically toward (θ, φ)= (±30°,90°), as depicted in FIG. 9A.

The optimized reactive loads to achieve the desired reflected field are shown in FIG. 9B. The scattered field from the metasurface with the loads attached is shown in FIG. 9C. This plot clearly demonstrates that the incident wave is indeed being reflected toward an orthogonal azimuthal plane, with two different elevation angles. Additionally, the normalized radiation pattern along the H-plane (φ=90°) is shown in FIG. 9D. The reflected field computed using Ansys HFSS with optimized loads attached and the anticipated scattered field computed using MATLAB match the desired reflected field.

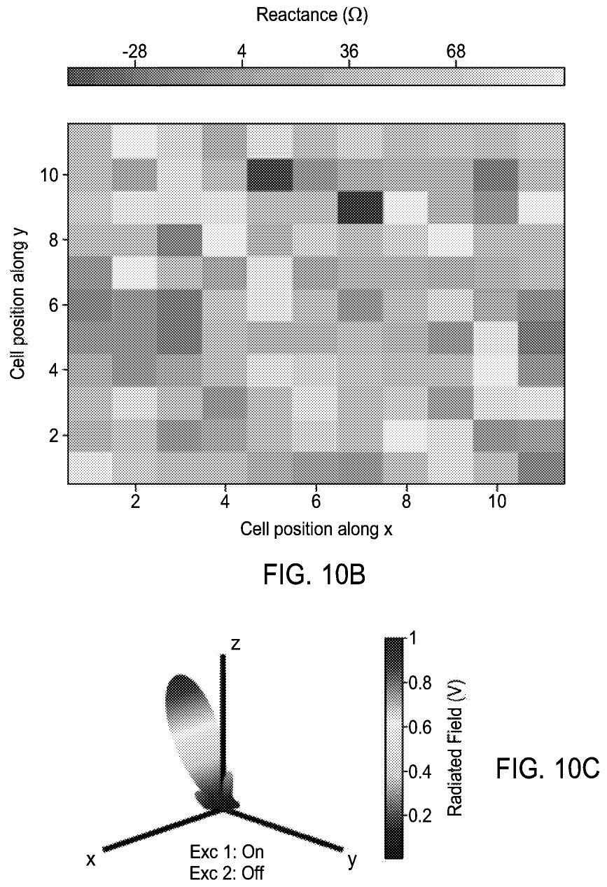

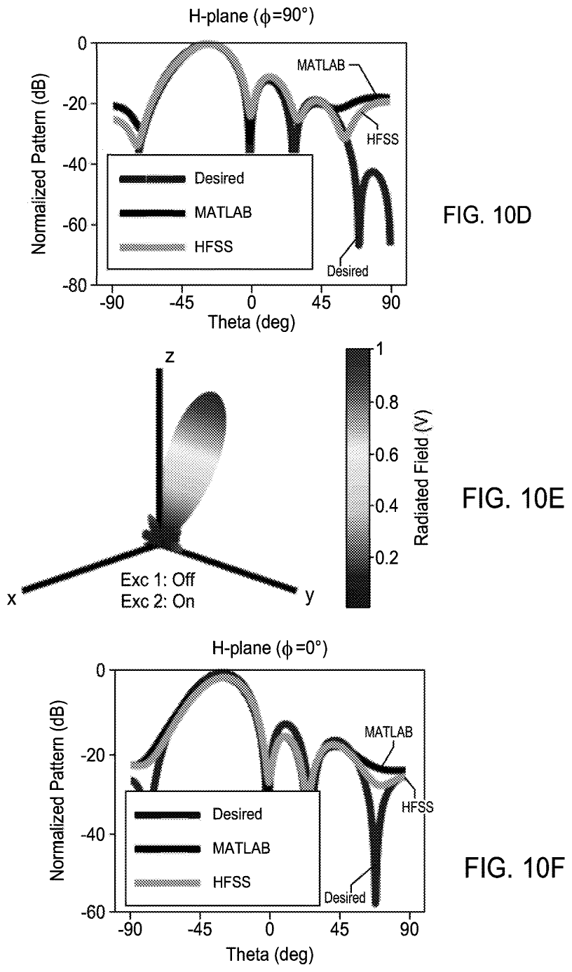

In this example, the metasurface is excited with two different plane waves. The goal is to reflect each plane wave into a different direction. This multi-functional performance is possible with the proposed technique. The first plane wave is incident from (θᵢ, φᵢ)=(30°, 0°) and the goal is to reflect this plane wave towards an orthogonal azimuthal plane (θᵢ, φᵢ)=) (−30°,90°). The second plane wave is incident from (θᵢ, φᵢ)=(30°, 90°) and the goal is to reflect it towards (θᵢ, φᵢ)=(−30°, 0°). The desired field transformation is illustrated in FIG. 10A.

The optimized reactive loads are shown in FIG. 10B. The designed reflective metasurface with the loads attached is simulated in Ansys HFSS to verify its performance. The radiation pattern when the metasurface is excited by the first plane wave is shown in FIG. 10C. The field is reflected toward the desired angle. Similarly, when the metasurface is excited by the second plane wave it reflects the field towards the second desired angle, as shown in FIG. 10E. The normalized radiation patterns in FIG. 10D and FIG. 10F show close agreement with the desired radiation patterns.

The optimized reactive loads are implemented using different lengths of microstrip lines on the third layer of the metasurface. Meandered, open-circuited microstrip lines are used to cover the desired range of optimized reactive loads. The input impedance for the meandered open-circuited line is extracted from the fullwave solver. The length of an open-circuited microstrip line is varied in order to match its input impedance to that of the straight microstrip line terminated with a lumped impedance load. To validate the realization procedure, one directly-fed and one reflecting metasurface are implemented.

In another aspect of this disclosure, an alternative synthesis technique is proposed in which a metasurface composed of multiple unit cells is modeled using an admittance Y-matrix extracted from a single full-wave simulation. The target far-field pattern is first projected onto the active element patterns of the unit cells to determine the required voltage distribution across the unit cells. The Y-matrix is then modified by engineered non-local coupling network to realize these voltages, thereby synthesizing complex far-field radiation patterns while maintaining passivity and losslessness. By precisely manipulating the mutual interaction between unit cells, the non-local metasurface introduces a new degree of freedom for shuttling power across the aperture in a controlled manner. Importantly, all steps following the initial extraction of the Y-matrix and the active element patterns are performed analytically, significantly reducing computational complexity.

By way of background, the proposed metasurface consists of N+1 unit cells, each connected to a port. These unit cells are divided into two categories: excited cells and terminated (loaded) cells. The electromagnetic behavior of the metasurface can be described using an admittance matrix representation:

$$\\ \begin{matrix}[ \begin{matrix}{\overline{I}}^{L} \\ {\overline{I}}^{E}\end{matrix} ] = [ \begin{matrix}{\overline{\overline{Y}}}^{LL} \\ {\overline{\overline{Y}}}^{EL}\end{matrix} \begin{matrix}{\overline{\overline{Y}}}^{LE} \\ {\overline{\overline{Y}}}^{EE}\end{matrix} ] [ \begin{matrix}{\overline{V}}^{L} \\ {\overline{V}}^{E}\end{matrix} ] & ( 26 )\end{matrix}$$

Here, the superscript L denotes the terminated (loaded) cells, while E denotes the excited cells. The total far-field radiated from the metasurface is calculated by summing the far-field contributions from all unit cells:

Eₜₒₜ=V̅^{T}Ē_{C} (27)
where V̅ is a complex vector whose entries represent the voltages at each unit cell, and Ē_{c} contains the active element patterns of the individual cells, accounting for both polarizations as a function of the observation angles.

To synthesize a target radiation pattern, the goal is to determine the voltage distribution V̅ that generates it. This is accomplished by projecting the target far-field pattern onto the basis formed by the active element patterns of the individual unit cells which yields the following linear system:

Q̅=C̅V (28)
where Q̅ is the projection of the target far-field pattern onto the active element patterns of the individual unit cells:

Q̅=[ [symbol] E_{targ},E₁ [symbol] , [symbol] E_{targ},E₂ [symbol] , . . . , [symbol] E_{targ},E_{N+1} [symbol] )]^{T} (29)

Here, the operator <A,B> denotes the inner product of the two vector far-field patterns over the radiation sphere:

$$\\ \begin{matrix}〈 A , B 〉 = {\int }_{0}^{2 π} {\int }_{0}^{π} A \cdot {B}^{*} d θ d ϕ & ( 30 )\end{matrix}$$

The matrix C̅ is the coupling matrix, whose entries quantify the overlap (mutual coupling) between the active element patterns of the unit cells:

$$\\ \begin{matrix}\overline{\overline{C}} = [ \begin{matrix}〈 {E}_{1} , {E}_{1} 〉 & 〈 {E}_{1} , {E}_{2} 〉 & ⋯ & 〈 {E}_{1} , {E}_{N + 1} 〉 \\ 〈 {E}_{2} , {E}_{1} 〉 & 〈 {E}_{2} , {E}_{2} 〉 & ⋯ & 〈 {E}_{2} , {E}_{N + 1} 〉 \\ ⋮ & ⋮ & ⋱ & ⋮ \\ 〈 {E}_{N + 1} , {E}_{1} 〉 & 〈 {E}_{N + 1} , {E}_{2} 〉 & ⋯ & 〈 {E}_{N + 1} , {E}_{N + 1} 〉\end{matrix} ] & ( 31 )\end{matrix}$$

This matrix formulation establishes a linear relationship between the desired far-field projection, the coupling among unit cells, and the required voltage distribution for metasurface synthesis. A direct solution for V̅ can be obtained by inverting the coupling matrix, C̅. However, this procedure is often ill-conditioned and can yield voltage distributions with rapid oscillations and high sensitivity to small perturbations. To address these issues, a regularized synthesis method is introduced that enforces smoothly varying voltage distribution to the unit cells.

A regularization method is used to overcome the ill-conditioning of the coupling matrix, C̅, and to ensure smoothly-varying voltage excitations. In an example embodiment, Tikhonov regularization is employed to improve the stability of the solution and reduce sensitivity to small perturbations and numerical noise.

The objective of the synthesis problem is to solve the following regularized least-squares problem:

$$\\ \begin{matrix}{min}_{\overline{V}} {‖ \overline{\overline{C}} \overline{V} - \overline{Q} ‖}_{2}^{2} + γ {‖ \overline{V} ‖}_{2}^{2} & ( 32 )\end{matrix}$$

where γ is the regularization parameter. The regularized least-square problem has a closed-form solution:

$$\overline{V} = {( {\overline{\overline{C}}}^{H} \overline{\overline{C}} + γ \overline{\overline{U}} )}^{- 1} {\overline{\overline{C}}}^{H} \overline{Q} \qquad ( 33 )$$

where Ū̅ is the identity matrix, and (·)^{H} denotes the Hermitian transpose.

To determine an appropriate value of γ, an L-curve method is employed. The L-curve is a log-log plot of the residual norm

$$\\ {‖ \overline{\overline{C}} \overline{V} - \overline{Q} ‖}_{2}^{2}$$

versus the solution norm

$${‖ \overline{V} ‖}_{2}^{2}$$

for a range of regularization parameter. The regularization parameter governs the trade-off between penalizing highly oscillatory voltage magnitudes and fitting the projection vector Q̅. For small values of γ, the residual norm is minimized (yielding a better match to the target radiation pattern) but at the expense of oscillatory voltages. Conversely, larger values of γ suppress oscillations and yield smoother voltages, but at the expense of degraded radiation pattern match. The optimal point is at the corner of the L-curve that represents the best trade off between the two extremes.

The objective in beamforming metasurface design is the synthesis of target fields or radiation patterns in a passive and lossless manner. A straightforward direct solution (through matrix inversion) for the metasurface sheet impedance or load impedance often yields complex values with both real and imaginary parts. This implies the need for either positive or negative resistances, which complicates physical realization.

Prior techniques employed optimization to eliminate the real part of the impedances. These optimization techniques introduce abrupt variations in the impedances, which in turn excite surface waves that redistribute power across the metasurface.

Rather than relying on shuttling power around with surface waves, one can introduce engineered physical interconnects between unit cells. These nonlocal connections, implemented through mutual admittances, enable controlled power exchange between neighboring cells. Specifically, both the self-admittances and nearest-neighbor coupling admittances are engineered to achieve the target excitation voltages.

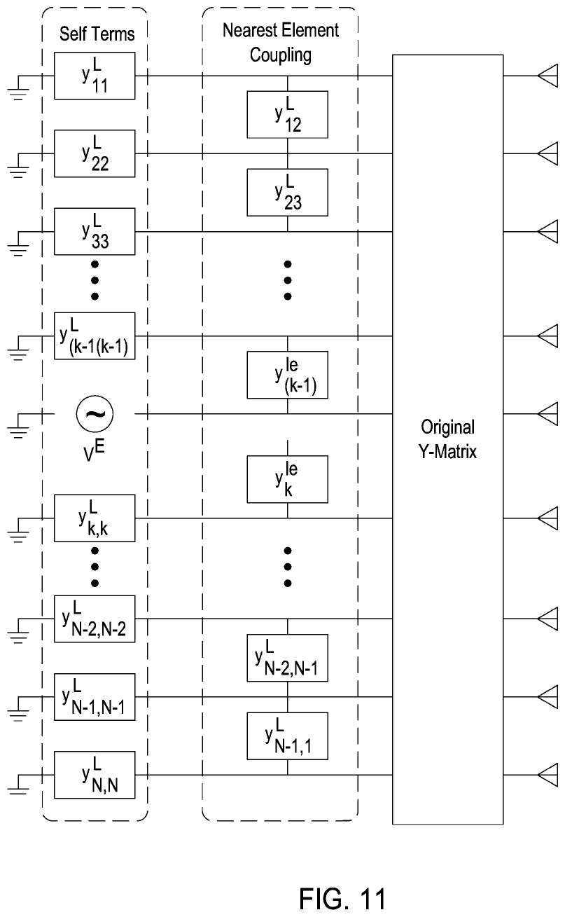

Consider a metasurface with N+1 unit cells, where a single cell is excited by an external voltage source and the remaining N cells require voltage synthesis. Each voltage is complex, yielding a total of 2N real variables. To satisfy these requirements, one can introduce 2N degrees of freedom through the self-admittances and the nearest-neighbor coupling admittances, as illustrated in FIG. 11. The metasurface with added coupling network can be described using a Y-matrix of the form:

$$[ \begin{matrix}\overline{0} \\ {I}^{E}\end{matrix} ] = [ \begin{matrix}{\overline{\overline{Y}}}^{LL} + {\overline{\overline{y}}}^{L} & {\overline{\overline{Y}}}^{LE} + {\overline{\overline{y}}}^{le} \\ {\overline{\overline{Y}}}^{EL} + {\overline{\overline{y}}}^{le} & {\overline{\overline{Y}}}^{E E}\end{matrix} ] [ \begin{matrix}{\overline{V}}^{L} \\ {V}^{E}\end{matrix} ] \qquad ( 34 )$$

Here, y̅^{L} represents the coupling network, comprising selfadmittances and nearest-neighbor coupling admittances, while y̅^{le} represents the additional coupling between the excited cell and its nearest loaded neighbors. The coupling network, y̅^{L}, is lossless and symmetric, and it has a tridiagonal form:

$${\overline{\overline{y}}}^{L} = j [ \begin{matrix}{B}_{11}^{L} & {B}_{12}^{L} & 0 & 0 & ⋯ & 0 \\ {B}_{12}^{L} & {B}_{22}^{L} & {B}_{23}^{L} & 0 & ⋯ & 0 \\ 0 & {B}_{23}^{L} & {B}_{33}^{L} & {B}_{34}^{L} & ⋱ & ⋮ \\ 0 & 0 & {B}_{34}^{L} & ⋱ & ⋱ & 0 \\ ⋮ & ⋮ & ⋱ & ⋱ & {B}_{( N - 1 ) ( N - 1 )}^{L} & {B}_{( N - 1 ) N}^{L} \\ 0 & 0 & ⋯ & 0 & {B}_{( N - 1 ) N}^{L} & {B}_{NN}^{L}\end{matrix} ] \qquad ( 35 )$$

Since the loaded cells adjacent to the excited cell (indexed k) are not directly interconnected, the coupling susceptance B₍ₖ₋₁₎ₖ is set to zero. Additional coupling to the excited cell is instead introduced through two non-zero susceptances in y̅^{le}:

$${\overline{\overline{y}}}^{le} = {j [ \begin{matrix}0 & ⋯ & 0 & {B}_{( k - 1 )}^{le} & {B}_{k}^{le} & 0 & ⋯ & 0\end{matrix} ]}^{T} \qquad ( 36 )$$

From the first row of (34), the total current into the loaded cells is:

$${\underbrace{- {\overline{\overline{Y}}}^{LL} {\overline{V}}^{L} - {\overline{\overline{Y}}}^{LE} {V}^{E}}}_{{\overline{I}}_{s}} = {\overline{\overline{y}}}^{L} {\overline{V}}^{L} + {\overline{\overline{y}}}^{le} {V}^{E} \qquad ( 37 )$$

The left-hand side represents a known current, denoted by Īₛ, due to the original network (without the coupling network) and the solved target voltages V̅^{L} and V^{E}. The right-hand side contains the coupling network to be determined. This relation can be expressed compactly as the following augmented linear system:

$${\overline{I}}_{s} = [ {\overline{\overline{y}}}^{L} \vert {\overline{\overline{y}}}^{le} ] [ \begin{matrix}{\overline{V}}^{L} \\ {V}^{E}\end{matrix} ] \qquad ( 38 )$$

where the two admittance matrices are concatenated horizontally, and the voltage vectors are stacked vertically. Each row of the linear system in (38) can be written explicitly as:

$${I}_{si} = {jB}_{ii}^{L} {V}_{i}^{L} + {jB}_{i ( i + 1 )}^{L} {V}_{i + 1}^{L} + {jB}_{i ( i - 1 )}^{L} {V}_{i - 1}^{L} + {jB}_{i}^{le} {V}^{E} \qquad ( 39 )$$

Since the susceptances are the unknown design parameters, the set of equations in (39) can be assembled into a compact linear system as follows:

Iₛ=jv̅B (40)

In this formulation, the matrix v̅ ∈ [symbol] ^{N×2N} is constructed from the known voltages and encodes the contribution of each susceptance to the resulting currents. The unknown vector B̅ ∈ [symbol] ^{2N×1} collects all nonzero susceptances of the coupling network, including the self-susceptances of the loaded cells, the nearest-neighbor coupling susceptances between adjacent loaded cells, and the susceptances coupling the loaded cells to the excited cell. The susceptance vector B is structured as:

$$B = [ \begin{matrix}{B}_{11}^{L} \\ ⋮ \\ {B}_{NN}^{L} \\ {B}_{12}^{L} \\ {B}_{23}^{L} \\ ⋮ \\ {B}_{( k - 2 ) ( k - 1 )}^{L} \\ {B}_{k ( k + 1 )}^{L} \\ ⋮ \\ {B}_{( N - 1 ) N}^{L} \\ {B}_{( k - 1 )}^{le} \\ {B}_{k}^{le}\end{matrix} ] \qquad ( 41 )$$

Correspondingly, the matrix v̅ is decomposed into three submatrices that reflect these three classes of coupling terms:

v̅=[v̅⁽¹⁾|v̅⁽²⁾|v̅⁽³⁾] (42)

The first matrix v̅⁽¹⁾ is diagonal with entries equal to V̅_{L}, representing the coefficients of the self-admittance terms. The second matrix, v̅⁽²⁾, captures the nearest-neighbor coupling between the loaded cells and is defined using the following block matrices structure:

$${\overline{\overline{v}}}^{( 2 )} = [ \begin{matrix}\overline{\overline{D}} ( 0 , k - 2 ) & \overline{\overline{0}} \\ \overline{\overline{0}} & \overline{\overline{D}} ( k - 1 , N - k )\end{matrix} ] \qquad ( 43 )$$

where k denotes the index of the excited cell among the N+1 unit cells, and the block matrix D̅(n, m) is given by:

$$\overline{\overline{D}} ( n , m ) = [ \begin{matrix}{V}_{n + 2}^{L} & 0 & ⋯ & 0 \\ {V}_{n + 1}^{L} & {V}_{n + 3}^{L} & ⋱ & ⋮ \\ 0 & {V}_{n + 2}^{L} & ⋱ & 0 \\ ⋮ & ⋱ & ⋱ & {V}_{n + m + 1}^{L} \\ 0 & ⋯ & 0 & {V}_{n + m}^{L}\end{matrix} ] \qquad ( 44 )$$

The matrix v̅⁽³⁾ contains two column vectors associated with coupling to the excited cell. The first column vector is nonzero only at row k−1 and has a value equal to V^{E}. The second column vector is non-zero only at row k, also with a value equal to V^{E}.

Equation (40) defines a system with N equations and 2N unknowns. By separating real and imaginary parts, one obtains a solvable system:

$$[ \begin{matrix}\text{?} \{ {\overline{I}}_{s} \} \\ \text{?} \{ {\overline{I}}_{s} \}\end{matrix} ] = [ \begin{matrix}\text{?} \{ \overline{\overline{J}} v \} \\ \text{?} \{ \overline{\overline{J}} v \}\end{matrix} ] B \qquad ( 45 )$$

This system can be solved for the passive and lossless coupling network that achieves the desired voltages and, consequently, the target radiation patterns.

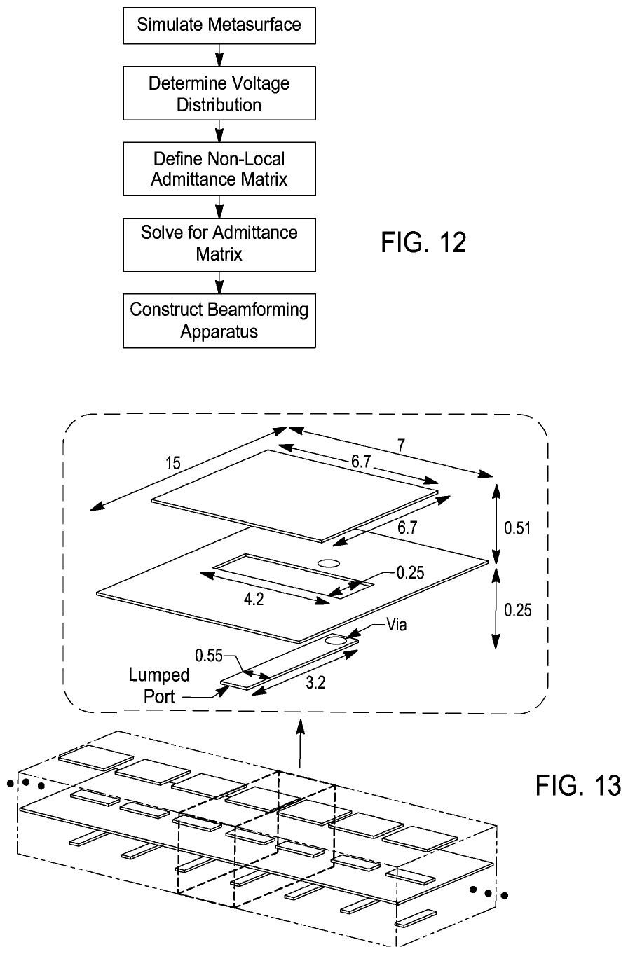

FIG. 12 illustrates this alternative technique for synthesizing radiation patterns for metasurfaces. The metasurface is divided into a plurality of unit cells, where at least one unit cell in the plurality of unit cells is electromagnetically coupled or electrically connected to a respective excitation source and remainder of the unit cells in the plurality of unit cells are electromagnetically coupled or electrically connected to respective electrical loads.

First, the metasurface is simulated at 71 using an electromagnetic field solver, thereby deriving a simulated admittance matrix for the metasurface and an active radiation pattern for each unit cell in the plurality of unit cells. A voltage distribution for the metasurface is then determined at 72, for example by decomposing the desired radiation pattern into individual radiation patterns for each unit cell in the plurality of unit cells, thereby defining a linear system representing the metasurface.

Next, a non-local admittance matrix for the metasurface is defined at 73. Elements of the non-local admittance matrix include a self-admittance term and one or more coupling terms, such that the one or more coupling terms represent admittance between a given unit cell and a nearest neighbor unit cell. Using the voltage distribution for the metasurface and a known excitation current for the one or more excitation sources, one can solve for the non-local admittance matrix at 74. Solving for the non-local admittance matrix yields the coupling network (i.e., self-admittance and nearest-neighbor coupling admittances) needed to form the desired radiation pattern.

Lastly, a beamforming apparatus is constructed at 75 in accordance with the non-local admittance matrix. Specifically, the beamforming apparatus is comprised of a metasurface disposed on a top surface of a substrate and a load layer disposed on a bottom surface of the substrate, where load layer supports a plurality of electric loads that are electromagnetically coupled or electrically connected to respective units cells of the metasurface.

FIG. 13 depicts an example metasurface having aperture-coupled unit cells. Each unit cell is composed of three layers: a patch layer, a ground plane with apertures, and a microstrip line layer. The unit cell dimensions are optimized to achieve impedance matching to a 50 Ω microstrip line at the bottom layer. This unit cell topology is particularly suitable for the engineered coupling network, as the adjacent microstrip ports on the bottom layer can be easily interconnected, allowing precise control of nearest-neighbor interactions. This is critical for implementing the non-local admittance connections.

For illustration purposes, all design examples in this disclosure assume a metasurface composed of 19 unit cells, corresponding to a total length of 4.4/0 at the operating frequency of 10 GHz. The unit cells are implemented by stacking two dielectric substrates with a relative permittivity of 3. The metasurface is first pre-characterized via a full-wave solver (e.g., Ansys HFSS) to extract its Y-matrix, and the active element pattern of each unit cell. This characterization is performed using a single forward simulation. The active element pattern is subsequently used to synthesize the required voltage distribution to produce the target radiation pattern. The extracted Y-matrix is then used to determine the coupling network needed to realize the target voltages when the center cell is excited by a voltage source. While the following design examples are for a metasurface with a single excitation source, the synthesis technique described above can also be applied to metasurfaces having two or more excitation sources.

Three design examples are presented below to validate the proposed approach. In the first design example, the goal is to synthesize a radiation pattern with equal side-lobe levels, corresponding to a Dolph-Chebyshev distribution. The target far-field pattern is defined using an ideal array factor:

$${E}_{targ} = A F ( θ ) = {\sum }_{n = - ( N - 1 ) / 2}^{( N - 1 ) / 2} {w}_{n} {e}^{j ( {k}_{o} ndsin θ )} \qquad ( 46 )$$

where k₀ is the free-space wavenumber, d is the spacing between unit cells, and wₙ are the Dolph-Chebyshev excitation coefficients. These coefficients are computed to produce an equal side-lobe level of −20 dB, and a main beam steered to θ₀=−40°.

It is well-known that idealized excitations based on analytical array factors do not account for mutual coupling between elements or edge effects at the array boundary. As a result, port excitations equal to those of the excitation coefficients would lead to an inaccurate radiation pattern. To address this, the synthesis procedure is applied to calculate the precise voltage that needs to be applied to each unit cell to accurately reproduce the target far-field radiation pattern, accounting for mutual coupling.

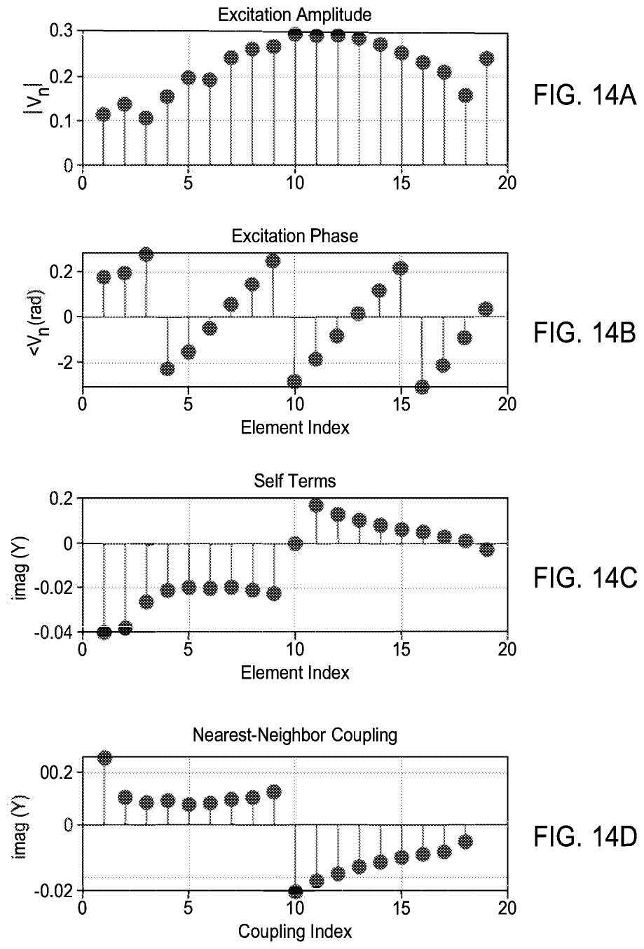

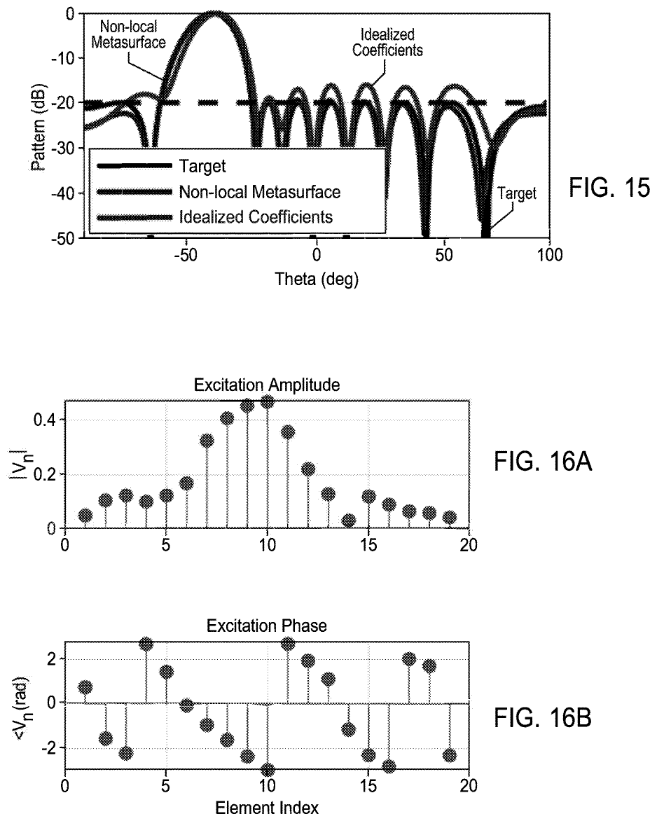

The resulting complex voltages, obtained from (33), are shown in FIGS. 14A and 14B. The voltages exhibit a smooth variation across the metasurface unit cells. Using the synthesis technique from above, the corresponding self-admittances and nearest-neighbor coupling admittances are determined to realize these voltages when the center unit cell is excited. The computed admittances are shown in FIGS. 14C and 14D. The resulting radiation pattern is shown in FIG. 15 for two different cases. The target radiation pattern is plotted in black, the radiation pattern obtained when only the center unit cell is excited and all the remaining cells are terminated by the engineered non-local coupling network is shown in blue, and the radiation pattern with port excitations equal to those of excitation coefficient wn is shown in red. The proposed nonlocal metasurface approach closely reproduces the target radiation pattern, with the main beam directed toward θ₀=−40° and side-lobe levels near the desired −20 dB. Minor deviation from the target pattern arise due to the regularization applied to enforce smoothly-varying voltages across the metasurface. In contrast, the idealized excitation coefficients fail to reproduce the target radiation pattern, clearly highlighting the importance of the synthesis procedure, which allows for a single feed and accounts for mutual coupling and different element patterns.

In the second design example, the objective is to synthesize a flat-top radiation pattern spanning the angular range from θ=0° to θ=40°. This radiation pattern can be generated by assigning excitation coefficients, wₙ, to the array factor in (46) as:

$${w}_{n} = sinc ( \frac{n}{B W} ) {e}^{{jk}_{o} ndsin {θ}_{o}} , \qquad ( 47 )$$

where θ₀=20° denotes the beam center, and BW=5 controls the angular bandwidth of the radiation pattern.

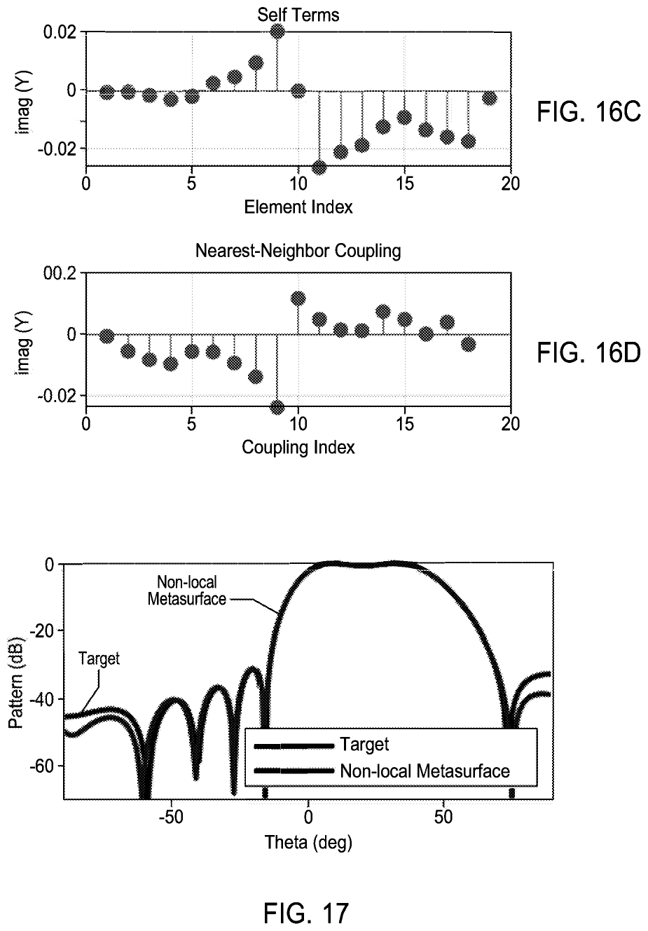

The synthesized complex voltages across the metasurface unit cells are shown in FIGS. 16A and 16B. Using the technique described above, the self-admittances and nearest-neighbor coupling admittances are calculated to produce these voltages when the center element is excited. The required admittance values are presented in FIGS. 16C and 16D. Finally, the radiation pattern produced by the non-local metasurface is shown in FIG. 17. The pattern demonstrates a flattop region extending from θ=0° to θ=40° with suppressed side-lobes outside this angular window.

In the third example, a multi-beam antenna is synthesized using the proposed technique. Multibeam metasurface antennas are often designed by directly superimposing multiple impedance profiles, a strategy that typically leads to degraded radiation patterns. In contrast, the method presented here overcomes these limitations and enables an accurate multi-beam antenna.

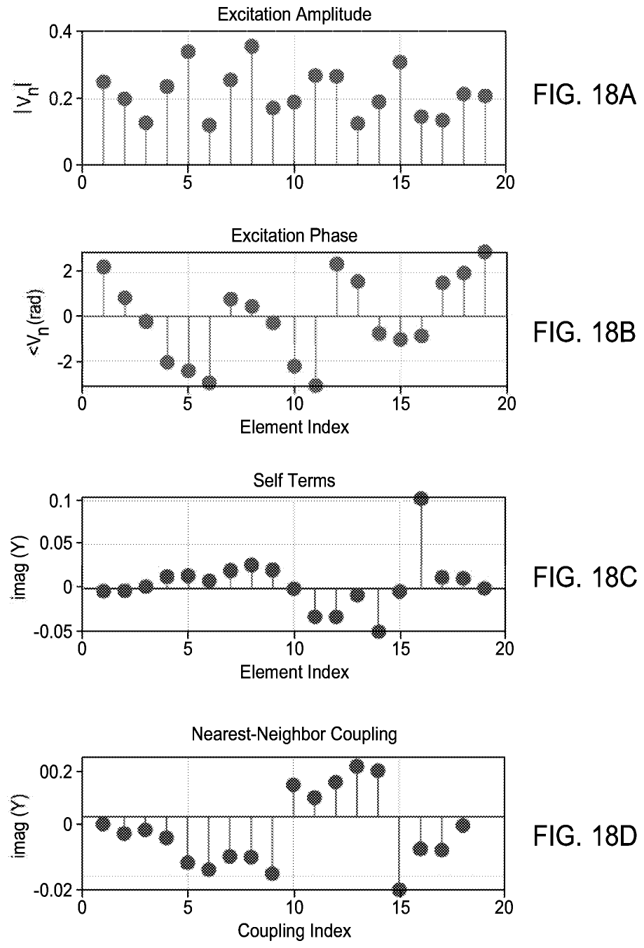

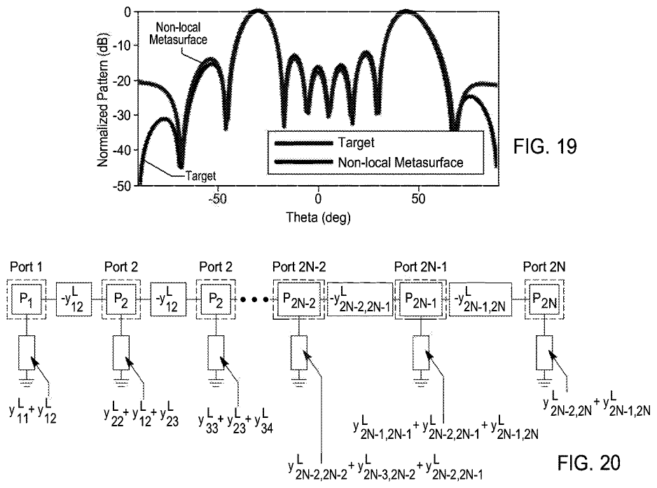

The objective is to radiate simultaneously towards two directions: θ₁=−30° and θ₂=45 . . . . The complex voltage distribution obtained from the synthesis procedure is shown in FIGS. 18A and 18B. The corresponding self-admittances and nearest neighbor coupling admittances, derived when the center element is excited, are provided in FIGS. 18C and 18D. The resulting radiation pattern closely matches the target multi-beam pattern, as illustrated in FIG. 19.

To physically implement the synthesized coupling network, microstrip-based reactive loadings are employed. The implementation is modeled using a TT-equivalent circuit representation to capture both self-admittances and nearest-neighbor coupling admittances. A generalized TT-equivalent circuit for the coupling network, where each unit cell is coupled only to its immediate neighbors, is illustrated in FIG. 20.

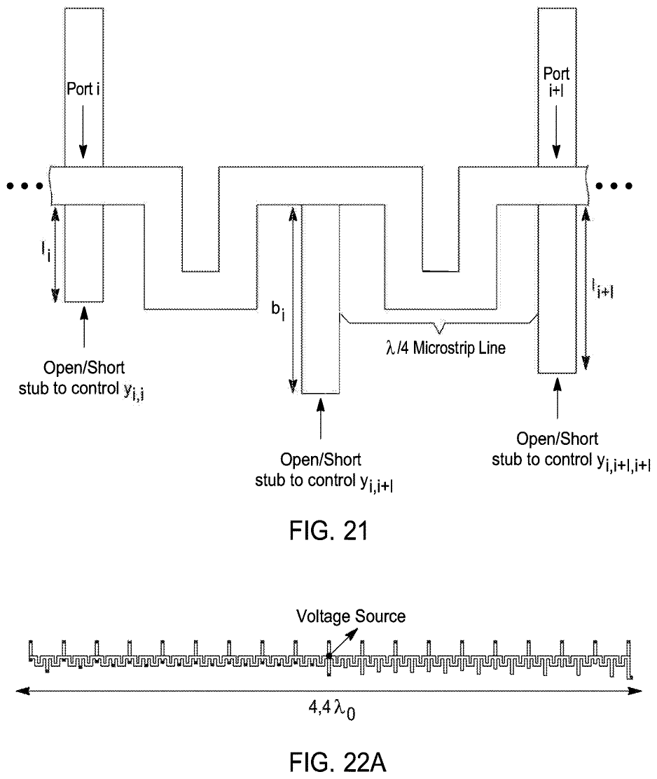

The proposed realization mechanism is implemented using microstrip line interconnects. The bottom layer of the metasurface with these interconnections is shown in FIG. 21. Each port is terminated with an open or short stub of length li, which controls the self-admittance. Additionally, neighboring unit cells are interconnected using a λ/4 microstrip lines, each followed by an open or short stub of length bi to control the nearest-neighbor coupling admittance. The λ/4 microstrip line transforms the shunt load (open/short stub) into an equivalent series load at the port, enabling direct realization of the required nearest-neighbor coupling admittance. This configuration provides full reactive control of the mutual admittance solely through adjusting the stubs length. It is worth noting that some parasitic effects may arise from microstrip line bends and discontinuities. Therefore, once all stubs are placed, a fullwave simulation should be performed to extract the updated admittance matrix of the coupling network, and fine-tune the lengths of the stubs for accurate matching to the required coupling network.

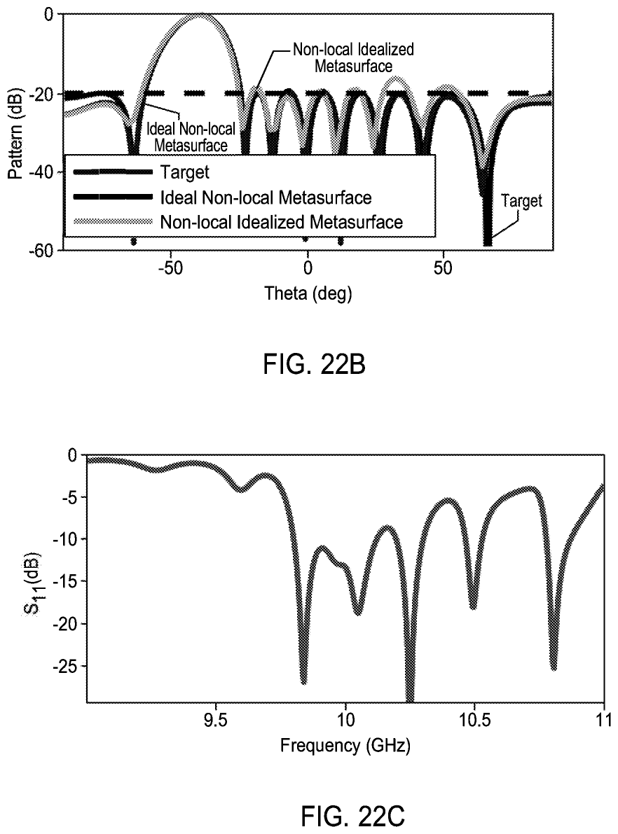

The realization method is applied to Design Example 1, which produces a Dolph-Chebyshev radiation pattern with a prescribed side-lobe level. The calculated self-admittances and nearest-neighbor coupling admittances shown in FIGS. 14C and 14D are directly mapped onto the length of the stubs. The bottom layer of the metasurface is shown in FIG. 22A. This metasurface is simulated using Ansys HFSS full-wave solver to evaluate its performance. The center cell of the metasurface is excited with a voltage source, and the resulting radiation pattern is shown in FIG. 22B. The realized non-local metasurface can accurately reproduce the target radiation pattern, which demonstrates the feasibility of this method. Additionally, the reflection coefficient extracted from Ansys HFSS is shown in FIG. 22C, confirming that the non-local metasurface is matched to the 50 Ω microstrip line.

Although the method was demonstrated for a linear array of unit cells (one-dimensional), the same formulation can be used for planar (two-dimensional) metasurfaces, enabling more advanced beamforming. Furthermore, incorporating additional coupling admittances offers a path toward more complex functionalities, such as analog signal processing and wavebased computing.

The techniques for designing the beamforming metasurface described herein may be implemented in part by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for implementing the design process. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A beamforming apparatus, comprising:
a substrate;
an electromagnetic metasurface disposed on a top surface of the substrate and configured to produce simultaneous beams, where the metasurface is divided into a plurality of unit cells;
a load layer disposed on a bottom surface of the substrate and supporting a plurality of electrical loads; and
two or more excitation sources electromagnetically coupled or electrically connected to respective unit cells in the plurality of unit cells, such that remainder of unit cells in the plurality of unit cells are electromagnetically coupled or electrically connected to respective electrical loads of the plurality of electrical loads.

2. The beamforming apparatus of claim 1 wherein the plurality of electrical loads are further defined as reactive loads.

3. The beamforming apparatus of claim 1 further comprises a controller configured to control the plurality of electrical loads.

4. The beamforming apparatus of claim 1 wherein the controller determines values for the plurality of electrical loads by
defining a desired radiation pattern for beams to be produced by the beamforming apparatus;
simulating the metasurface to derive an impedance matrix for the metasurface;
determining an active radiation pattern for each unit cell in the plurality of unit cells;
determining a total radiation pattern for the metasurface based in part on the active radiation patterns of the plurality of unit cells; and
determining values for the plurality of electrical load by aligning the total radiation pattern to the desired radiation pattern.

5. The beamforming apparatus of claim 4 wherein the controller simulates the metasurface using an electromagnetic field solver.

6. The beamforming apparatus of claim 4 wherein the controller determines active radiation patterns using an electromagnetic field solver.

7. The beamforming apparatus of claim 4 wherein the controller determines the total radiation pattern by
setting excitation currents of the two or more excitation sources;
calculating the load currents for unit cells terminated with electrical loads using the impedance matrix; and
superimposing active radiation patterns for each unit cell, where the active radiation patterns are weighted by their respective load current.

8. The beamforming apparatus of claim 4 wherein the controller determines values for the plurality of electrical loads by iteratively updating the values of the plurality of electrical loads through optimization until a cost function is minimized.

9. The beamforming apparatus of claim 8 wherein the cost function is defined as
g=minimize{E_{des}−Eₜₒₜ}+minimize{Γ}
where E_{des} is the desired radiation pattern, Eₜₒₜ is the total radiation pattern and Γ is a reflection coefficient matrix.

10. A beamforming apparatus, comprising:
a substrate;
an electromagnetic metasurface disposed on a top surface of the substrate and configured to produce simultaneous beams, where the metasurface is divided into a plurality of unit cells; and
a load layer disposed on a bottom surface of the substrate and supporting a plurality of electrical loads, wherein each unit cell in the plurality of unit cells is electromagnetically coupled or electrically connected to a respective electrical load.

11. The beamforming apparatus of claim 10 wherein the plurality of electrical loads are further defined as reactive loads.

12. The beamforming apparatus of claim 10 further comprises a controller configured to control the plurality of electrical loads.

13. The beamforming apparatus of claim 10 wherein the controller determines values for the plurality of electrical loads by
defining a desired radiation pattern for beams to be produced by the beamforming apparatus;
simulating the metasurface to derive an impedance matrix for the metasurface;
determining an active radiation pattern for each unit cell in the plurality of unit cells;
determining a total radiation pattern for the metasurface based in part on the active radiation patterns of the plurality of unit cells; and
determining values for the plurality of electrical load by aligning the total radiation pattern to the desired radiation pattern.

14. The beamforming apparatus of claim 13 wherein the controller simulates the metasurface using an electromagnetic field solver.

15. The beamforming apparatus of claim 13 wherein the controller determines active radiation patterns using an electromagnetic field solver.

16. The beamforming apparatus of claim 13 wherein the controller determines the total radiation pattern by
setting excitation currents of the two or more excitation sources;
calculating the load currents for unit cells terminated with electrical loads using the impedance matrix; and
superimposing active radiation patterns for each unit cell, where the active radiation patterns are weighted by their respective load current.

17. The beamforming apparatus of claim 13 wherein the controller determines values for the plurality of electrical loads by iteratively updating the values of the plurality of electrical loads through optimization until a cost function is minimized.

18. The beamforming apparatus of claim 17 wherein the cost function is defined as
g=minimize{E_{des}−Eₜₒₜ}+minimize{Γ}
where E_{des} is the desired radiation pattern, Eₜₒₜ is the total radiation pattern and Γ is a reflection coefficient matrix.

19. A computer-implemented method for designing a beamforming apparatus to produce a desired radiation pattern for two or more beams emitted from the beamforming apparatus, comprising:
providing a metasurface divided into a plurality of unit cells, where two or more units cells in the plurality of unit cells are electromagnetically coupled or electrically connected to respective excitation sources and remainder of the unit cells in the plurality of unit cells are electromagnetically coupled or electrically connected to respective electrical loads;
simulating the metasurface using an electromagnetic field solver, thereby deriving an impedance matrix for the metasurface and
an active radiation pattern for a plurality of unit cells;
determining, by the computer processor, a total radiation pattern for the metasurface based in part on the active radiation patterns of the plurality of unit cells; and
determining, by the computer processor, values for the plurality of electrical load by aligning the total radiation pattern to the desired radiation pattern.

20. A computer-implemented method for designing a beamforming apparatus to produce a desired radiation pattern for one or more beams emitted from the beamforming apparatus, comprising:
providing a metasurface divided into a plurality of unit cells, where at least one unit cell in the plurality of unit cells is electromagnetically coupled or electrically connected to a respective excitation source and remainder of the unit cells in the plurality of unit cells are electromagnetically coupled or electrically connected to respective electrical loads;
simulating the metasurface using an electromagnetic field solver, thereby deriving a simulated admittance matrix for the metasurface and an active radiation pattern for each unit cell in the plurality of unit cells;
determining, by a computer processor, a voltage distribution for the metasurface by decomposing the desired radiation pattern into individual radiation patterns for each unit cell in the plurality of unit cells, thereby defining a linear system representing the metasurface;
defining a non-local admittance matrix for the metasurface, where elements of the non-local admittance matrix include a self-admittance term and one or more coupling terms, such that the one or more coupling terms represent admittance between a given unit cell and a nearest neighbor unit cell; and
solving, by the computer processor, for the non-local admittance matrix using the voltage distribution for the metasurface and a known excitation current for the one or more excitation sources.

21. The computer-implemented method of claim 20 further comprises constructing the beamforming apparatus in accordance with the non-local admittance matrix, where the beamforming apparatus is comprised of a metasurface disposed on a top surface of a substrate and a load layer disposed on a bottom surface of the substrate.

22. The computer-implemented method of claim 21 wherein neighboring unit cells of the metasurface are interconnected by microstrips having lengths defined by the non-local admittance matrix.

23. The computer-implemented method of claim 20 wherein determining a voltage distribution for the metasurface includes expressing the desired radiation pattern as a linear combination of individual radiation patterns for each unit cell in the plurality of unit cells.

24. The computer-implemented method of claim 20 further comprises applying regularization method to the linear system prior to the step of solving for the admittance matrix.

25. The computer-implemented method of claim 24 wherein the regularization method is further defined as Tikhonov regularization method.
